(19) United States
(12) Patent Application Publication
(10) Pub. No.: US 2012/0239553 A1
(43) Pub. Date: Sep. 20, 2012

(54) METHOD FOR PROCESSING AND FUNDING SHORT-TERM LOANS TO A CONSUMER AND A METHOD FOR CONVERTING CURRENCY, BOTH TO A MOBILE CREDIT STORAGE FACILITY ACCOUNT

(75) Inventors: Jonathan A. Gonen, Calabasas, CA (US); Shlomo Gonen, Calabasas, CA (US); David Gonen, Calabasas, CA (US)

(73) Assignee: METRO ENTERPRISES, INC., Los Angeles, CA (US)

(21) Appl. No.: 13/421,737

(22) Filed: Mar. 15, 2012

Related U.S. Application Data
(60) Provisional application No. 61/453,418, filed on Mar. 16, 2011.

(51) Int. Cl. G06Q 20/40; G06Q 20/32

(52) U.S. Cl. 705/38

(57) ABSTRACT

A system for processing and funding short-term loans to a mobile credit storage facility account, including providing currency exchange services to the mobile credit storage facility account. Loan types include short-term loans, payday loans, micro credit loans, mobile telecommunication carrier top-off loans and overdraft loans. Loans may be based on an applicant's loan application, history of employment or mobile money creditworthiness including mobile money historical transactions and mobile phone company records. Loan funds may be deposited directly to the consumer's account that is associated with his/her mobile device. They may also be automatically debited for various payments. The consumer's mobile device telephone or IMEI number is used as a unique identifier to established and analyze a credit history and to facilitate the mobile money transactions.

### FIELD OF THE INVENTION

The present invention generally relates to mobile banking. More particularly, the present invention relates to a method for processing and funding loans to a mobile device and telephone number account. The present invention also relates to currency exchange/conversion of funds in mobile accounts.

### BACKGROUND OF THE INVENTION

The advent of mobile money has allowed mobile users the ability to receive funds, transfer funds, pay bills, purchase both tangible and intangible goods as well as to buy telecommunication carrier airtime, all without a bank account. This essentially creates “cashless” financial transactions where no physical currency is actually exchanged.

Also, mobile users are increasingly storing value onto their mobile devices, with the user's mobile telephone number serving as a unique identifier and short messaging service (SMS) acting as the way in which mobile money transactions take place. These technological advances, coupled with the fact that many people throughout the world do not have access to the traditional banking system and financial products such as short-term loans and currency exchange services, allows for new ways to perform traditional financial services in lending and currency.

Accordingly, there is a need for a system and process for processing and funding mobile money loans to a mobile device and corresponding telephone number account. Furthermore, there is a need for providing currency exchange services to a mobile credit storage facility. The present invention fulfills these needs and provides other related advantages.

### SUMMARY OF THE INVENTION

The present invention is directed to a method for processing and funding short-term loans for a consumer. The inventive method begins with establishing a mobile credit storage facility account for the consumer and linking that mobile credit storage facility account to a mobile device associated with the consumer. The entity implementing the method then receives an application for a short-term loan from the consumer through the mobile device. The application is processed and the entity either grants or rejects approval of the short-term loan. The grant or rejection of approval of the short-term loan is communicated to the consumer through the mobile device, and funding of the short-term loan is deposited into the mobile credit storage facility account linked to the consumer's mobile device.

Establishing the mobile credit storage facility account includes acquiring identification information about the consumer. The identification information may include a mobile device identification number, a legal name, and/or a social security number. The identification information is stored in a data storage facility associated with a computer server. The identification information is used to record or establish credit history and to process transactions in the mobile credit storage facility account. Where the identification information is a mobile device identification number, such number is a mobile telephone number or an IMEI number associated with the mobile device.

Loan terms as sought by the borrower/consumer are transmitted with the application to the entity implementing the process. Such borrower loan terms include loan amount, term of loan, interest rate and/or repayment schedule as sought by the consumer. The short-term loan may be a payday loan, a micro credit loan, a financial institution overdraft loan, a mobile telecommunication carrier top-off loan, or a mobile payment processor loan.

Processing the application includes the following: verifying the identity of the consumer; optionally requesting additional information from the consumer; analyzing the application to determine purchase and payment patterns, account balances, interest rates, and/or earnings potential; and determining offer loan terms that are acceptable to a lender or the entity implementing the method based upon the analysis of the application. The identity of the consumer is verified through the identification information, including, mobile telephone number, mobile device IMEI number, legal name, social security number, address, birthdate, and/or account number. The optional additional information comprises employment history, banking history and balances, credit history and balances, monetary assets and liabilities, rental/mortgage history, earnings history, tax returns history, telecommunications services history, mobile financial transactions history, and/or utilities history. Verifying the identity of the consumer includes comparing the mobile device identification number against identifying information stored in the data storage facility.

Determining offer loan terms includes forwarding the application to the lender for approval. Determining offer loan terms may be performed by a computer server applying pre-determined loan-approval algorithms to calculate offer loan terms, including a loan amount. Analyzing the application may also be performed by a computer server applying pre-determined loan-approval algorithms to calculate the consumer's creditworthiness.

Communicating includes communicating the offer for an approved short-term loan along with the approved loan terms. The lender or entity implementing the method offers an approved short-term loan to the consumer. The approved loan terms comprise a loan amount, a term of loan, an interest rate and/or a repayment schedule. After an offer is accepted, the consumer's mobile credit storage facility account is periodically debited in an amount for repayment of the short-term loan. The repayment amount includes interest, fees, charges, and principal. The debited money is transferred to either the entity implementing the method or the lender according to the repayment schedule. The transfer of the short-term loan repayment amount is by Short Messaging Service (SMS) or USSD short code. The consumer and the entity/lender may mutually agree to a repayment schedule based upon a consumer's employment paydays, or annuity paydays or other scheduled income expectation.

Receiving the application may be effected by a mobile transmission method, including, short messaging service, email, internet browser, telephone, smart phone mobile app interface, interactive voice response system, or drop-down menu within the operating system of the mobile device. Communicating the grant or rejection may also be effected by a mobile transmission method, including, short messaging service, email, internet browser, telephone, smart phone mobile app interface, interactive voice response system, or drop-down menu within the operating system of the mobile device.

The consumer may be provided with a way to contact a loan assistant regarding the application via a smart phone mobile app interface, electronic messaging, online chat, email, SMS messaging, or a telephone call.

Depositing funding of the short-term loan may be effected by Short Messaging Service (SMS) funds transfer, Contactless Near Field Communication (CNFC) mobile payment transfer, WAP mobile payments transfer, Direct Mobile Billing transactions, or voice biometrics technology. Monetary funds may be debited from the mobile credit storage facility account for a repayment amount of the short-term loan via Short Messaging Service (SMS) funds transfer, Contactless Near Field Communication (CNFC) mobile payment transfer, WAP mobile payments transfer, Direct Mobile Billing transactions, or voice biometrics technology. If insufficient funds are available in the mobile credit storage facility account to cover the repayment amount, the mobile credit storage facility account may be periodically pinged and the repayment amount may be automatically debited when sufficient funds are available.

When the short-term loan is a payday loan, the entity/lender may arrange for the consumer's employer to make payroll payments directly into the mobile credit storage facility account.

When the short-term loan comprises a mobile telecommunication carrier top-off loan or a financial institution overdraft loan, and the entity/lender may detecting the balance of the mobile credit storage facility account and automatically process a standing application for a short-term loan if the balance of the mobile credit storage facility account is below a pre-determined threshold.

A mobile credit score for the consumer and the associated mobile device may be calculated. The mobile credit score is based upon loan and payment history, any previous defaults, risk assessment, transaction size, interest rate and additional information, including, employment history, banking history and balances, credit history and balances, monetary assets and liabilities, rental/mortgage history, earnings history, tax returns history, telecommunications services history, and/or utilities history.

The present invention is also directed to a method for converting currency, particularly the currency of funds in an established mobile credit storage facility account. Funds of a first currency associated with a first country location are electronically deposited into the mobile credit storage facility account. A second country location is established and a conversion rate for converting the funds in the first currency into a second currency associated with the second country location is determined. At least a portion of the funds in the mobile credit storage facility account are electronically converted from the first currency to the second currency based upon the conversion rate.

Once the conversion is completed, funds in the second currency are made available through the mobile credit storage facility account for mobile payments. The mobile payments may be effected by Short Messaging Service (SMS) funds transfer, Contactless Near Field Communication (CNFC) mobile payment transfer, WAP mobile payments transfer, Direct Mobile Billing transactions, or voice biometrics technology.

Prior to any conversion, the mobile credit storage facility account verified and the adequacy of the funds in the mobile credit storage facility account is confirmed. Determining a conversion rate includes determining currency exchange rates, interbank rates, foreign exchange options, bid and ask rates, and/or associated transaction exchange fees.

Establishing a second country location is automatic and occurs upon either a predetermined schedule or a change in the geographic location of the mobile device.

Funds in the second currency may be exchanged from the mobile credit storage facility account via an electronic request to a physical currency exchange facility. Once funds are exchanged to a physical exchange facility, the funds may be dispensed in physical bills of the second currency. Funds in the second currency in the mobile credit storage facility account may be utilized for mobile payments via Short Messaging Service (SMS) funds transfer, Contactless Near Field Communication (CNFC) mobile payment transfer, WAP mobile payments transfer, Direct Mobile Billing transactions, or voice biometrics technology.

The mobile credit storage facility account may be a mobile wallet account, a near field communication (NFC) based account, a mobile banking account, a smart phone mobile app, a carrier/bank cooperation account, or a short messaging service (SMS) based transactional account.

Converting the funds may be automatic and occur upon either a predetermined schedule or a change in the geographic location of the mobile device. Similarly, determining a conversion rate may be automatic and occur upon either a predetermined schedule or a change in the geographic location of the mobile device.

At least a portion of the funds in the mobile credit storage facility account may be electronically reconverted from the second currency back into the first currency based upon a current conversion rate.

A conversion option may be communicated to a holder of the mobile credit storage facility account, wherein the holder has the right but not the obligation to exercise the conversion option. The conversion option comprises a pre-agreed conversion rate on a specified future date.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a flow-chart of an exemplary method for processing and funding short-term loans to a consumer; and

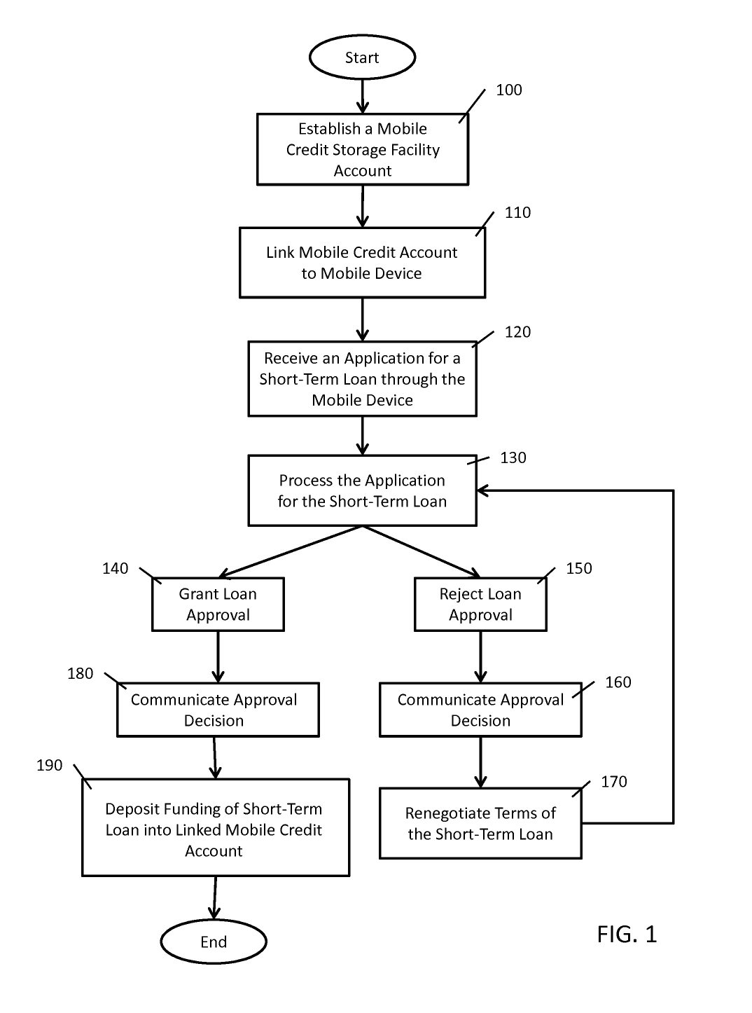

FIG. 2 is a flow-chart of an exemplary method for converting currency.

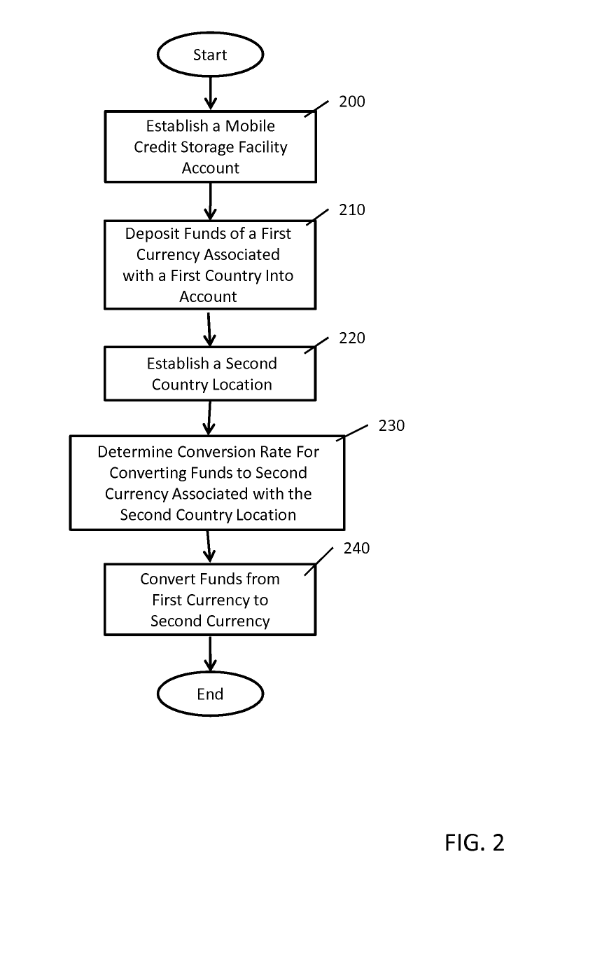

### DETAILED DESCRIPTION OF THE PREFERRED EMBODIMENTS

The present invention for a system and method for creating a mobile money account and processing and funding short-term loans associated with that account. The present invention is also drawn to using a mobile money account to provide currency exchange services. The mobile money account is associated with a mobile device of the user/consumer, enabling the user to make financial transactions quickly and easily, no matter where he is. The present invention supplants the need for an account holder to have a bank account, bank checks, or direct deposit. Additionally, mobile money currency exchange services allow an account holder to use his account funds anywhere in the world.

An overdraft loan is defined as occurring when money is withdrawn from a financial account and the available balance goes below zero. Even though the user has a negative account balance, funds are extended to this user to ensure the user's transaction is not rejected, with fees and interest charges charged for this service.

A Top-Off Credit or Top-off Loan occurs when a telecommunications carrier account is overdrawn, with an insufficient amount of minutes or credits available, and a credit or a loan is extended so that the user can continue to complete transactions, with fees and interest charged for this service

A Payment Processor is defined as any entity which processes payments and also seeks to issue loans or extend credit to the users it is servicing.

A mobile credit storage facility account is a mobile account or mobile application with stored value associated with it (in the form of money or credits).

A mobile device is any hand-held computing device which includes smartphones and mobile tablets. Some examples include all versions of the iPad, iPhone, Windows phone, Android phone or Blackberry device.

Short-Term Loans

The present invention is directed to a method for processing and funding short-term loans for a consumer. The inventive method begins with establishing a mobile credit storage facility account for the consumer (100) and linking that mobile credit storage facility account to a mobile device associated with the consumer (110). The entity implementing the method then receives an application for a short-term loan from the consumer through the mobile device (120). The application is processed (130) and the entity either grants (140) or rejects (150) approval of the short-term loan. The grant or rejection of approval of the short-term loan is communicated to the consumer through the mobile device (160, 180). If approval of the loan is rejected, then the terms of the loan are renegotiated (170) and the method returns to the processing step (130) to review the renegotiated terms. If approval of the loan is granted, then funding of the short-term loan is deposited into the mobile credit storage facility account linked to the consumer's mobile device (190).

For the establishment of a mobile money or mobile credit storage facility account, the user applies to open such an account with an appropriate entity in a manner similar to opening a bank account - only this account is linked to a mobile device associated with the consumer. The account is established by the entity implementing the method and is created with information that identifies the user; such as name, birthday, address, social security number, password, employment history, banking information, mortgage information, wage earnings, tax returns, telecommunication services, utilities (i.e., gas and electric), bills, records, and statements. The mobile money account also includes other information that helps in the determination as to whether to fund the requested loan. This additional information includes: credit history, transaction history, payment processing transaction history, account balances, and account data trends. This information is provided by the user, or by a financial company, telecommunications institution, or payment processing company.

The user information for the mobile money account is stored in a data storage facility coupled with a server computer and can be accessed by any internet-enabled device. When the user wishes to utilize his mobile money account via his mobile device, he must associate his mobile device with his mobile money account. He can associate his mobile device with his mobile money account via either the mobile telephone number assigned to his mobile device, or via the International Mobile Equipment Identity (“IMEI”) number assed to his mobile device. Once this association is made, the phone number or the IMEI number acts as the user's unique identity, and any transaction request that comes from that phone or IMEI number is then funded back to the associated mobile device.

Once a mobile device is associated with a mobile money account, the mobile money server owner may offer financial products and services directly to the user on his mobile device. These offers may take the form of a mobile transmission method, i.e., short messaging service (“SMS”), email, internet browser, telephone, smart phone application interface, interactive voice response (“IVR”), or via drop-down menu existing within the operating system platform of the mobile device.

In one exemplary embodiment, the user applies for a short-term mobile money loan. Short-term loans may include payday loans, micro credit loans, mobile telecommunication carrier top-off loans (airtime credits or funds used to purchase airtime credits), and overdraft loans. The short-term loan process includes the steps of: 1) drafting a loan application using a mobile device application interface, 2) using the mobile device to then send the loan application for processing, 3) receiving a loan application from a user, 4) verifying the information provided in the application, 5) determining whether to provide the loan, 6) entering into a loan repayment plan with the loan applicant that includes terms and condition, and 7) dispensing the loan funds.

First, the loan applicant can be drafted on the loan applicant's mobile device, once the mobile device is associated with his mobile money account. If the loan applicant has questions or problems during the loan application process, he is permitted to contact a human representative via his mobile device through electronic messaging, chat, email, SMS messaging or a spoken voice call. The human representative may also be contacted if the resulting loan application is declined. A loan application can also be forwarded from or provided by a loan applicant's financial institution or telecommunications company. Typically, when a loan applicant is approaching or has a zero mobile money balance, he will initiate contact with the mobile money loan service, a mobile money loan facilitator or affiliate, his mobile carrier, or telecommunications company for an extension of mobile money credit. This ensures that the loan applicant's mobile money funds or credits are replenished.

Alternately, a mobile user can sign up with his mobile carrier or telecommunications company for an automatic top-off loan or an extension of mobile money credit when his stored credit or stored mobile money funds reach a certain minimum threshold. Loan applications can be automatically generated based on a loan applicant's top-off needs according to data emanating from the loan applicant's mobile telecommunications transactions history. For example, if the loan applicant's account balance fell below a certain numeric threshold, a top-off loan would be automatically applied for. This numeric threshold which causes an automated mobile carrier top-off loan application can include a zero balance. This would allow for the loan applicant to not be rejected from a carrier account transaction and avoid having a negative account balance. Alternatively, the loan application may be auto-generated by a financial institution upon the loan applicant reaching his overdraft limit. For example, if the loan applicant's account balance fell below a certain numeric threshold, an overdraft loan would be automatically applied for. This numeric threshold which causes an automated overdraft loan application can include a zero balance, and would also allow for the user to not be rejected from an account transaction and avoid having a negative account balance. Notifications can be set up in the loan applicant's mobile money account settings that will notify the loan applicant when his account funds are getting low and when a loan has automatically been applied for on his behalf.

The mobile money mobile device application can also be used to draft and send short-term loan applications to third-party lenders, creditors, micro credit institutions, or loan facilitators. Loan applications to these third-parties or to the mobile money server can be sent via SMS, or unstructured supplementary service data (“USSD”) short code technology.

Once the loan application is submitted, the information in the loan application is verified against the information associated with the mobile money account. All identifying information must match up in order for the process to continue. After successful verification, the determination is made as to whether to provide the requested loan.

This determination is based on a number of factors, and can be performed by a computer or by a person. Part of the determination is based on a numerical expression that represents the payment and loan experience, and factors in default, risk assessment, payment history, transaction size and interest rates, as well as other variables. This is done for the purpose of producing a credit score for the mobile money account and associated mobile device. Each mobile money transaction contributes positively or negatively to this credit score. The credit score may also be grouped with other mobile money account data provided by mobile phone companies, banking institutions, employers, landlords, insurance companies, government departments, or other third parties. All this data can influence the mobile money account holder's credit report and score.

If a computer is performing the determination, the computer will aggregate data regarding: credit scores, mobile transactions, user finances, bill payment history, credit requests over time, monetary assets, and liabilities. Payday loans are determined based upon the payroll cycle qualities of the loan applicant. This information can be gathered from the loan applicant's mobile money account, mobile telephone companies, banking institutions, micro credit institutions, and credit bureau entities. This information allows a computer to determine the creditworthiness of the mobile money loan or credit extension request. This computer method can be initiated automatically when a mobile money account reaches a zero balance or when the account reaches some other figure pre-determined by the mobile user.

If the loan application is for a payday loan, the funding determination is primarily based on the loan applicant having an employer who makes payroll payments directly to the applicant's mobile credit storage facility account. It is also beneficial if the employer of the loan applicant has employed the applicant for a long duration, makes consistent salary payments, makes salary payments in a predictable manner (including weekly, monthly, bi-monthly salary payroll deposits) and combinations thereof. Also beneficial is of the loan applicant's employee wages are direct deposited to the loan applicant's mobile credit storage facility account. Payday loans are typically in amounts that correspond with the scheduled payroll proceeds that the loan applicant receives from his employer. The payday loan determination can also factor in an applicant's upcoming employment. Alternately, the payday loan determination may be based on any type of future recurring deposit.

If the loan application is rejected, the process may come to an end or the loan provider or applicant may revise the loan terms, conditions, interest rates and amount of the loan via one of the mobile messaging methods so as to renew the application. If the loan application is accepted by the company, the company responds to the mobile user via one of the mobile transmission methods (SMS, USSD, etc.) with the terms of the loan. The loan applicant may reject or accept the loan offering. If the loan applicant rejects the offering, the process may come to an end, or the applicant may revise the terms of the loan and resubmit the application. If a loan application has been sent by the mobile money account holder, or the mobile money server to a third party financial institution, that third party may send the loan decision request to the mobile money server.

Loan terms include a repayment schedule. The repayment schedule may be based on the loan applicant's employer paydays. If the repayment schedule is payday based, the mobile money loan interest rate, fees, charges, and principal may be periodically transferred back to the lender according to the applicant's pay days. These repayment transfers can be effected using SMS or USSD short The agreement as to the terms of the loan can be confirmed via SMS, email, or Interactive Voice Response message. The confirmation can be made as to one or all of the following: contractual terms, funding amount, repayment schedule, interest rate, fees, charges, loan duration, loan covenants, and other terms found in similar types of loans. Loan documentation including a repayment or debit schedule agreement with the user's bank, telecommunications company or employer, may be required from the loan customer.

After an agreement between the loan applicant and lender has been reached, the loan funds can be dispersed in a number of ways. The most preferred method of fund dispersal is direct deposit to the loan applicant's mobile money account connected mobile device. Funds dispersed to the mobile device are stored in a credit storage facility. If loan funds are dispersed this way, the loan is funded to the mobile device having the phone number or IMEI number associated with the loan applicant's mobile money account. Loan funds are sent to the mobile device via SMS funds transfer, Contactless Near Field Communication mobile payment transfer. WAP mobile payments transfer, or Direct Mobile Billing transactions or biometrics (“Voiceprint”) technology. Loans can be dispersed to the loan applicant's mobile money account directly from the telecommunications company, financial company, or the payment processing company. Alternately, the loan payment may come from the mobile money server. The provided loan funds may be the requested amount, or any amount less than the requested amount. To facilitate the transfer, the user's credit storage facility account information, as from a telecommunications carrier or financial institution, may be requested. Such credit storage facility account information may include account numbers, routing numbers, PIN numbers, or other access numbers to credit and debit the user's credit account.

Loan funding can also come from other mobile money accounts. For example, if a third party financial institution decides to fund a loan applicant's request, that third party institution may use its own mobile money funding to provide funding to the loan applicant's mobile money account. This is also true for third party payment processors. If the loan applicant has multiple mobile money accounts, he can configure his accounts to automatically disperse incoming funds in any number of ways. All the loan applicant has to do is accept the incoming funding, and his account settings will take over at that point.

Other types of payments may also be funded to the mobile money account. The mobile user may receive employment payments or earned income to the mobile device where it is stored in a credit storage facility. The mobile user may also receive a government stipend or another type of annuity payment to his mobile device where it is again stored in a credit storage facility. The mobile user may have a prepaid or postpaid mobile carrier account wherein funds may be debited until the account balance falls below a predetermined threshold or funds are fully depleted. The mobile user may also have a financial account associated with a mobile telephone number or mobile device (including wireless cellular phone, smart phone or tablet computing device) that allows the mobile user to store, receive and/or dispense mobile funds.

When the time comes to repay the loan, loan principal payments, interest payments, fee payments, or any other loan-associated fees can be debited from the loan user's mobile money account. Loan repayments can be initiated by the loan recipient, by mobile money, or by a third party loan provider. Additionally, loan repayments may be set up to occur automatically. Debits can be made via SMS funds transfer, Contactless Near Field Communication mobile payment transfer, WAP mobile payments transfer, Direct Mobile Billing transactions, USSD short code technology, or voice biometrics (“Voiceprint”) technology. These debits can be timed in conjunction with the loan user's employer paydays, where the mobile money loan interests, fees, charges, and principal are collected periodically and transferred back to the lender. The loan recipient may also choose to make a loan payment by check, bank transfer, or cash payment, either as the regular required payment or in addition to any regular required payment. Depending on the terms of the loan agreement, the user may be given a repayment choice, whether to make an interest payment or pay the principal and interest off entirely. Depending on the selected option, the loan agreement may be renewed, whereby a new loan with new loan terms may replace the previous agreement.

If there is insufficient mobile money loan funds available in a user's account to cover a mobile money loan payment, a computer server will periodically ping the user's mobile money account and withdraw the mobile money funds whenever sufficient funds become available. The mobile user may accept the option to cause the server computer to fund the mobile money account, without providing further input related to the funding of the account, and pre-determined by the user's mobile money account settings or server computer loan protocol and procedures.

Currency Conversion

The present invention is also directed to a method for converting currency, particularly the currency of funds in an established mobile credit storage facility account (200). Funds of a first currency associated with a first country location are electronically deposited into the mobile credit storage facility account (210). A second country location is established (220) and a conversion rate for converting the funds in the first currency into a second currency associated with the second country location is determined (230). At least a portion of the funds in the mobile credit storage facility account are electronically converted from the first currency to the second currency based upon the conversion rate (240).

In the method for providing currency exchange services, when the mobile device associated with the mobile money account is located where the currency is different, the mobile device may automatically send a currency exchange request. The information pertaining to the request must be verified. Verification takes into account the amount of funds currently stored in the applicant's mobile credit storage facility account, the amount of funds requested to be exchanged, and the currency into which the funds are to be exchanged. Next, the computer server determines whether to undertake the currency exchange based on the results of the verification. Then, the designated portion of the funds in the mobile money account is converted into the desired currency and that amount is dispensed to the user's mobile device account. Alternately, if the user chooses, the converted currency can be dispensed from a physical currency exchange facility/store, wherein the user receives physical currency.

Mobile currency exchange can be initiated by a mobile money account holder, or it can be automatically initiated. Automatic initiation can occur when the mobile device associated with the account changes geographic location. This means that the mobile money account holder's money changes with him as he travels from one geographic location to the next. Geographic changes can be tracked according to longitude and latitude, or any other technological method used to establish the locality of a mobile device, such as global positioning software (“GPS”), applications that access the mobile device's built in GPS transmitter/functionality, cellular tower triangulation, Wi-Fi triangulation, or IP address changes. The user can also manually identify a geographic locality change. Automatic conversion can be configured to convert all mobile money funds, or just a portion of the mobile money funds.

Automatic exchange can also be scheduled for a future date. In this case, the mobile money account holder may be planning a trip to a different country and wishes to have his mobile money funds converted at the same time as his trip. In this case, the account holder can be presented with an exchange proposal that includes a pre-agreed exchange rate. The account holder may accept this rate, or wait until the date of travel to see if rates improve.

The mobile money server may be partnered with a mobile user's telecommunication carrier, mobile bank, or mobile financial services vendor, who may then initiate contact with the mobile user.

Before the exchange is made, the mobile money account holder can be sent a currency exchange proposal from the computer server. This proposal includes the currency exchange rates, interbank rates, foreign exchange options, bid and ask rates, images of the local currency and flag, or a list of associated transaction exchange fees. Based on this proposal, the account holder may agree to the exchange but is not obligated to. In some instances a country may possess several types of currency. In instances where there are alternate currency options, the user may be notified for the options available and be given an opportunity to select which currency denomination use.

Once the mobile device user has received the proposal, he may choose to exchange the funds in his credit storage facility account to the new currency denomination. The mobile device user may choose to exchange only a portion of the funds in his credit storage facility account. In such case, the credit storage facility account may contain two or more currency denominations at the same time. The mobile device user may also be presented with several financial services vendor options along with the currency exchange rates and fees, user experience scoring for comparison, and terms and conditions for each of the vendor options. The mobile user may select among the available vendor options for currency exchange services.

The mobile currency exchange method can also be used in conjunction with any type of mobile credit storage facility account, including mobile wallet accounts, near field communication (“NEC”) based accounts, mobile banking accounts, mobile device smart phone applications, carrier/bank cooperation accounts, or SMS based transactional accounts. The mobile currency exchange method can also be used on other types of mobile devices including, a cellphone, a smart phone, a tablet device, or any other mobile wireless device.

In one embodiment of the mobile currency exchange method, the mobile device user sends funds from his credit storage facility to his mobile money account, or one of the mobile money affiliated vendors. The funds transfer takes place employing SMS based transfer, Near Field Communications based transfer, traditional bank transfer or wire, automated clearing house, mobile device smart phone application using data communication, unstructured supplementary service data (“USSD”), credit card, or bank check methodology. The mobile money server automatically determines exchange rates and fees based on the user's selected vendor, and deducts such associated fees and exchange rate spreads from the initiated mobile device funds transfer. The mobile money server transfers the converted currency funds back to the mobile device user's credit storage facility account. The mobile money server transfer takes place using one of the same methodologies discussed above.

In another embodiment, banks, telecommunication carriers, or financial services vendors who are partnered with the mobile money server send or advance funds to the credit storage facility account of the mobile device user. Then the bank, telecommunication carrier or financial service vendor debits the mobile device user's exchanged currency in the amount of the applicable currency exchange rates and fees. The mobile device user is left with the new currency denomination. Pursuant to a partnership agreement, the mobile money server reimburses the bank, telecommunication carrier or financial services vendor with which it is partnered for the credit storage facility funds transfer. It is this reimbursement that all associated fees and exchange rates are deducted.

If the mobile money account holder does not use all of his converted funds and wishes to convert his unused funds back to his original currency, he may request to sell back the currency funds stored on his mobile device.

In every exchange transaction, the mobile money account holder can receive a notification requesting him to exchange his currency, or informing him that his currency has been exchanged. Currency exchange services can be offered for a fixed fee or for a percentage fee of the total currency converted. Once the mobile money account holder's funds are exchanged, the exchanged funds are available on the associated mobile device for mobile payments, including SMS based transactional payments, Contactless Near Field Communication mobile payments, WAP mobile web payments, or direct mobile billing transactions.

Lastly, mobile money account holders can be offered financial products, services, and coupons based on their mobile device, mobile financial account spending, payment patterns, purchases, interest rates, and balances. These products, services, and coupons are meant to optimize the mobile user's financial decision making.

Although several embodiments have been described in detail for purposes of illustration, various modifications may be made to each without departing from the scope and spirit of the invention. Accordingly, the invention is not to be limited, except as by the appended claims.

What is claimed is:

1. A method for processing and funding short-term loans for a consumer, comprising the steps of:
establishing a mobile credit storage facility account for the consumer;
linking the mobile credit storage facility account to a mobile device associated with the consumer;
receiving an application for a short-term loan from the consumer through the mobile device;
processing the application for the short-term loan;
granting or rejecting approval of the short-term loan;
communicating the grant or rejection of approval of the short-term loan to the consumer through the mobile device; and
depositing funding of the short-term loan into the mobile credit storage facility account linked to the consumer's mobile device.

2. The method of claim 1, wherein the step of establishing the mobile credit storage facility account includes the step of acquiring identification information about the consumer, including a mobile device identification number, a legal name, and/or a social security number.

3. The method of claim 2, including the step of storing the identification information in a data storage facility associated with a computer server, wherein the identification information is used to record or establish credit history and to process transactions in the mobile credit storage facility account.

4. The method of claim 2, wherein the mobile device identification number comprises a mobile telephone number or an IMEI number associated with the mobile device.

5. The method of claim 1, including the step of transmitting borrower loan terms with the application, wherein borrow loan terms comprise loan amount, term of loan, interest rate and/or repayment schedule as sought by the consumer.

6. The method of claim 1, wherein the short-term loan is a payday loan, a micro credit loan, a financial institution overdraft loan, a mobile telecommunication carrier top-off loan, or a mobile payment processor loan.

7. The method of claim 1, wherein the processing step includes the steps of:
verifying the identity of the consumer;
optionally requesting additional information from the consumer;
analyzing the application to determine purchase and payment patterns, account balances, interest rates, and/or earnings potential; and
determining offer loan terms that are acceptable to a lender based upon the analysis of the application.

8. The method of claim 7, wherein the identity of the consumer is verified through identification information, including, mobile telephone number, mobile device IMEI number, legal name, social security number, address, birthdate, and/or account number

9. The method of claim 7, wherein the additional information comprises employment history, banking history and balances, credit history and balances, monetary assets and liabilities, rental/mortgage history, earnings history, tax returns history, telecommunications services history, mobile financial transactions history, and/or utilities history.

10. The method of claim 7, wherein the step of verifying the identity of the consumer includes comparing a mobile device identification number against identifying information stored in a data storage facility.

11. The method of claim 7, wherein the step of determining offer loan terms includes forwarding the application to the lender for approval.

12. The method of claim 7, wherein the step of determining offer loan terms is performed by a computer server applying pre-determined loan-approval algorithms to calculate offer loan terms, including a loan amount.

13. The method of claim 7, wherein the step of analyzing the application is performed by a computer server applying pre-determined loan-approval algorithms to calculate the consumer's creditworthiness.

14. The method of claim 1, wherein the communicating step includes communicating the offer for an approved short-term loan and approved loan terms.

15. The method of claim 14, wherein the communicating step comprises the step of a lender offering an approved short-term loan to the consumer, wherein the approved loan terms comprise a loan amount, a term of loan, an interest rate and/or a repayment schedule.

16. The method of claim 15, further comprises the steps of periodically debiting a short-term loan repayment amount, comprising, interest, fees, charges, and principal, from the mobile credit storage facility account and transferring that amount to the lender according to the repayment schedule.

17. The method of claim 16, wherein the transfer of the short-term loan repayment amount to the lender is by Short Messaging Service (SMS) or USSD short code.

18. The method of claim 15, further comprising the step of mutually agreeing to a repayment schedule based upon a consumer's employment paydays, or annuity paydays or other scheduled income expectation.

19. The method of claim 1, wherein the receiving step is effected by a mobile transmission method, including, short messaging service, email, internet browser, telephone, smart phone mobile app interface, interactive voice response system, or drop-down menu within the operating system of the mobile device.

20. The method of claim 1, wherein the communicating step is effected by a mobile transmission method, including, short messaging service, email, internet browser, telephone, smart phone mobile app interface, interactive voice response system, or drop-down menu within the operating system of the mobile device.

21. The method of claim 1, further comprising the step of providing the consumer with means for contacting a loan assistant via smart phone mobile app interface, electronic messaging, online chat, email, SMS messaging, or telephone call.

22. The method of claim 1, wherein the step of depositing funding of the short-term loan occurs via Short Messaging Service (SMS) funds transfer, Contactless Near Field Communication (CNFC) mobile payment transfer, WAP mobile payments transfer, Direct Mobile Billing transactions, or voice biometrics technology.

23. The method of claim 1, further comprising the step of debiting monetary funds from the mobile credit storage facility account for a repayment amount of the short-term loan via Short Messaging Service (SMS) funds transfer, Contactless Near Field Communication (CNFC) mobile payment transfer, WAP mobile payments transfer, Direct Mobile Billing transactions, or voice biometrics technology.

24. The method of claim 23, wherein if insufficient funds are available in the mobile credit storage facility account to cover the repayment amount, further comprising the step of periodically pinging the mobile credit storage facility account and automatically debiting the repayment amount when sufficient funds are available.

25. The method of claim 6, wherein when the short-term loan is a payday loan, further comprising the step of arranging for the consumer's employer to make payroll payments directly into the mobile credit storage facility account.

26. The method of claim 1, wherein the short-term loan comprises a mobile telecommunication carrier top-off loan or a financial institution overdraft loan, and further comprising the steps of detecting the balance of the mobile credit storage facility account and automatically processing a standing application for a short-term loan if the balance of the mobile credit storage facility account is below a pre-determined threshold.

27. The method of claim 1, further comprising the step of calculating a mobile credit score for the consumer and the associated mobile device, wherein the mobile credit score is based upon loan and payment history, any previous defaults, risk assessment, transaction size, interest rate and additional information, including, employment history, banking history and balances, credit history and balances, monetary assets and liabilities, rental/mortgage history, earnings history, tax returns history, telecommunications services history, and/or utilities history.

28. A method for converting currency, comprising the steps of:
establishing a mobile credit storage facility account;
depositing funds of a first currency associated with a first country location electronically into the mobile credit storage facility account;
establishing a second country location;
determining a conversion rate for converting the funds in the first currency into a second currency associated with the second country location; and
electronically converting at least a portion of the funds in the mobile credit storage facility account from the first currency to the second currency based upon the conversion rate.

29. The method of claim 28, further comprising the step of making funds in the second currency available through the mobile credit storage facility account for mobile payments.

30. The method of claim 29, wherein the mobile payments are effected by Short Messaging Service (SMS) funds transfer, Contactless Near Field Communication (CNFC) mobile payment transfer, WAP mobile payments transfer, Direct Mobile Billing transactions, or voice biometrics technology.

31. The method of claim 28, further comprising the steps of verifying the mobile credit storage facility account and the adequacy of the funds in the mobile credit storage facility account, prior to determining the amount of the funds to be converted into the second currency.

32. The method of claim 28, wherein the step of determining a conversion rate includes determining currency exchange rates, interbank rates, foreign exchange options, bid and ask rates, and/or associated transaction exchange fees.

33. The method of claim 28, wherein the step of establishing a second country location is automatic and occurs upon either a predetermined schedule or a change in the geographic location of the mobile device.

34. The method of claim 28, further comprising the step of exchanging funds in the second currency from the mobile credit storage facility account via an electronic request to a physical currency exchange facility, wherein the funds are dispensed in physical bills of the second currency.

35. The method of claim 28, further comprising the step of utilizing the funds in the second currency in the mobile credit storage facility account for mobile payments via Short Messaging Service (SMS) funds transfer, Contactless Near Field Communication (CNFC) mobile payment transfer, WAP mobile payments transfer, Direct Mobile Billing transactions, or voice biometrics technology.

36. The method of claim 28, wherein the mobile credit storage facility account comprises a mobile wallet account, a near field communication (NFC) based account, a mobile banking account, a smart phone mobile app, a carrier/bank cooperation account, or a short messaging service (SMS) based transactional account.

37. The method of claim 28, wherein the converting step is automatic and occurs upon either a predetermined schedule or a change in the geographic location of the mobile device.

38. The method of claim 28, wherein the determining step is automatic and occurs upon either a predetermined schedule or a change in the geographic location of the mobile device.

39. The method of claim 28, further comprising the steps of electronically reconverting at least a portion of the funds in the mobile credit storage facility account from the second currency back to the first currency based upon a current conversion rate.

40. The method of claim 28, further comprising the step of communicating a conversion option to a holder of the mobile credit storage facility account, wherein the holder has the right but not the obligation to exercise the conversion option.

41. The method of claim 40, wherein the conversion option comprises a pre-agreed conversion rate on a specified future date.
